(19) United States
(12) Patent Application Publication
(10) Pub. No.: US 2025/0148735 A1
(43) Pub. Date: May 8, 2025

(54) Methods and Systems for Providing a Space Extended Reality Service on Earth and an Earth Extended Reality Service on a Space Platform

(71) Applicants: Thales Alenia Space Italia S.p.A. Con Unico Socio, Roma (IT); Next One Film Group S.r.l., Roma (IT)

(72) Inventors: Domenico Tedone, Torino (IT); Valter Basso, Torino (IT); Alessandra Bonavina, Roma (IT)

(73) Assignees: Thales Alenia Space Italia S.p.A. Con Unico Socio, Roma (IT); Next One Film Group S.r.l., Roma (IT)

(21) Appl. No.: 18/838,541

(22) PCT Filed: Feb. 17, 2023
(86) PCT No.: PCT/IB2023/051453

§ 371 Date: Aug. 14, 2024

(30) Foreign Application Priority Data
Feb. 17, 2022 (EP) 22425006.8

(51) Int. Cl. G06T 19/20; G06T 7/70; G06T 13/40; G06V 40/16

(52) U.S. Cl. CPC G06T 19/20; G06T 7/70; G06T 13/40; G06V 40/174; G06T 2219/2004

(57) ABSTRACT

The invention concerns a method of providing a space extended reality service on earth, including: acquiring, by means of one or more acquisition systems/devices installed on a space platform, real-time data related to a surrounding space environment and/or to one or more astronauts in the space environment; generating, by means of a computer graphics processing device/system, based on the acquired real-time data and on synthetic data, a three-dimensional extended reality environment reproducing the space environment and one or more three-dimensional avatar(s) of the astronaut(s) reproducing movements and/or actions and/or facial expressions and/or voice of the astronaut(s), wherein the synthetic data digitally represent the space environment and/or the astronaut(s); and providing one or more users on earth with a space extended reality service based on the generated three-dimensional extended reality environment and avatar(s).

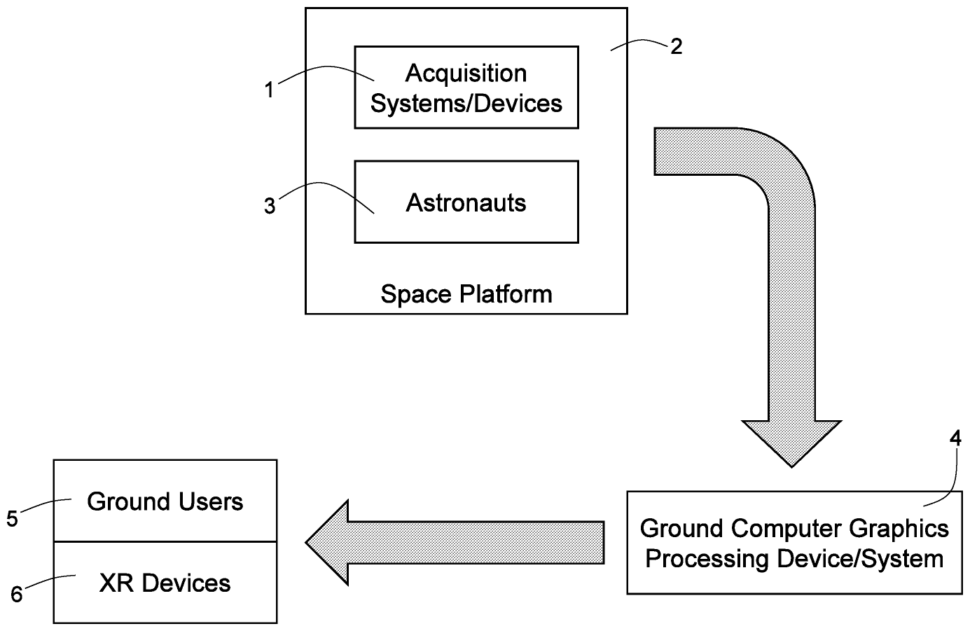

### CROSS-REFERENCE TO RELATED APPLICATIONS

This Patent Application claims priority from European Patent Application No. 22425006.8 filed on Feb. 17, 2022, the entire disclosure of which is incorporated herein by reference.

### TECHNICAL FIELD OF THE INVENTION

The present invention relates to mixed and virtual reality technologies (more in general, extended Reality (XR) technologies) exploited in combination, through the use of computer graphics, with digital modelling technologies such as those ones used by digital twin solutions.

More specifically, the present invention relates to a method and a system for providing a space extended reality service on earth, and to a method and a system for providing an earth extended reality service on a space platform.

### STATE OF THE ART

As is known, systems and devices currently used in the technical field of communications between personnel on earth and astronauts on space missions are mainly based on traditional audio and video technologies. In particular, audio communication systems currently used in the space sector are monophonic and, only in very few cases, stereophonic; additionally, communications based on visual contents are mainly implemented by means of two-dimensional (2D) systems and devices (mostly displays/monitors/screens displaying 2D images, videos, photos, diagrams, written texts, etc.).

Although the users of these systems (i.e., astronauts and ground control personnel) are used to communicating in a 2D way, it is absolutely clear that face-to-face communications are capable of transferring a wealth of information and emotions that audio/video media currently used in the space sector are unable to transmit. This certainly represents a limit that it is desirable to overcome, especially (but not only) in relation to safety aspects and to remote monitoring and control activities during space exploration missions.

Current space communication channels are adequate to transmit telemetry data and, more in general, binary information but, for long-duration manned space flights where human factors is a fundamental key, a “broader” channel becomes a necessity of human-to-human communication since, of the entire chain leading to the success of long-duration manned space flights, the human factor represents the weakest link in the chain. In fact, it is broadly known and widely documented in the scientific literature that poor communication is the most frequent cause of accidents in the aerospace sector (but not only), whereby disciplines such as cognitive ergonomics aim to address this issue.

### OBJECT AND SUMMARY OF THE INVENTION

An object of the present invention is to provide a system capable of overcoming the known limitations of current systems for space-to-earth and earth-to-space communications.

This and other objects are achieved by the present invention in that it relates to a method and a system for providing a space extended reality service on earth, and to a method and a system for providing an earth extended reality service on a space platform, as defined in the appended claims.

In particular, a method of providing a space extended reality service on earth according to the present invention comprises:
a) acquiring, by means of one or more acquisition systems/devices installed on a space platform, real-time data related to a surrounding space environment and/or to one or more astronauts in said space environment;
b) generating, by means of a computer graphics processing device/system, based on the acquired real-time data and on synthetic data, a three-dimensional (3D) extended reality environment reproducing the space environment and one or more 3D avatar(s) of the astronaut(s) reproducing movements and/or actions and/or facial expressions and/or voice of said astronaut(s), wherein the synthetic data digitally represent the space environment and/or the astronaut(s); and
c) providing one or more users on earth with a space extended reality service based on the generated 3D extended reality environment and avatar(s).

Additionally, a method of providing an earth extended reality service on a space platform according to the present invention comprises:
a) acquiring, by means of one or more acquisition systems/devices installed on earth, real-time data related to a surrounding ground environment and/or to one or more ground users in said ground environment;
b) generating, by means of a computer graphics processing device/system, based on the acquired real-time data and on synthetic data, a 3D extended reality environment reproducing the ground environment and one or more 3D avatar(s) of the ground user(s) reproducing movements and/or actions and/or facial expressions and/or voice of said ground user(s), wherein the synthetic data digitally represent the ground environment and/or the ground user(s); and
c) providing one or more astronauts on a space platform with an earth extended reality service based on the generated 3D extended reality environment and avatar(s).

### BRIEF DESCRIPTION OF THE DRAWING

For a better understanding of the present invention, a preferred embodiment, which is intended purely by way of a non-limiting example, will now be described with reference to the attached drawing (not to scale) that schematically illustrates an example of high-level system architecture according to an embodiment of the present invention.

### DESCRIPTION OF EMBODIMENTS OF THE INVENTION

The following discussion is presented to enable a person skilled in the art to comprehend, make and use the invention. Various modifications to the embodiments will be readily apparent to those skilled in the art, without departing from the scope of the present invention as claimed. Thence, the present invention is not intended to be limited to the embodiments shown and described, but is to be accorded the widest scope of protection consistent with the principles and features disclosed herein and defined in the appended claims.

The present invention concerns a method of providing a reality service on earth, said method space extended comprising:
a) acquiring, by means of one or more acquisition systems/devices installed on a space platform (e.g., a space module, a space station, a space vehicle, a spaceship, etc.), real-time data related to a surrounding space environment and/or to one or more astronauts in said space environment;
b) generating, by means of a computer graphics processing device/system, based on the acquired real-time data and on synthetic data, a three-dimensional (3D) extended reality environment reproducing the space environment and one or more 3D avatar(s) of the astronaut(s) reproducing movements and/or actions and/or facial expressions and/or voice of said astronaut(s), wherein the synthetic data digitally represent the space environment and/or the astronaut(s); and
c) providing one or more users on earth with a space extended reality service based on the generated 3D extended reality environment and avatar(s).

Preferably, the real-time data include data such as point clouds or the like that digitally represent body position and/or body attitude and/or facial expression of the astronaut(s).

Conveniently, the real-time data include images and/or photos and/or video data and/or audio data.

Preferably, the synthetic data are produced based on one or more computer-aided design models and/or one or more digital twin models that digitally represent the space environment and/or the astronaut(s).

Conveniently, the user(s) use(s) one or more extended reality devices to experience the space extended reality service.

The present invention relates also to the space extended reality service provided on earth by implementing the method as previously described and to a system designed to provide said space extended reality service on earth, wherein said system comprises:
one or more acquisition systems/devices installed on a space platform and configured to acquire real-time data related to a surrounding space environment and/or to one or more astronauts in said space environment; and
a computer graphics processing device/system that is installed on earth or on the space platform or, with a distributed architecture, partially on earth and partially on the space platform, and that is configured to receive the acquired real-time data and to carry out the steps b) and c) of the method as previously described.

Additionally, the present invention concerns also a method of providing an earth extended reality service on a space platform, said method comprising:
a) acquiring, by means of one or more acquisition systems/devices installed on earth, real-time data related to a surrounding ground environment and/or to one or more ground users in said ground environment;
b) generating, by means of a computer graphics processing device/system, based on the acquired real-time data and on synthetic data, a 3D extended reality environment reproducing the ground environment and one or more 3D avatar(s) of the ground user(s) reproducing movements and/or actions and/or facial expressions and/or voice of said ground user(s), wherein the synthetic data digitally represent the ground environment and/or the ground user(s); and
c) providing one or more astronauts on a space platform with an earth extended reality service based on the generated 3D extended reality environment and avatar(s).

Preferably, the real-time data include data such as point clouds or the like that digitally represent body position and/or body attitude and/or facial expression of the ground user(s).

Conveniently, the real-time data include images and/or photos and/or video data and/or audio data.

Preferably, the synthetic data are produced based on one or more computer-aided design models and/or one or more digital twin models that digitally represent the ground environment and/or the ground user(s).

Conveniently, the astronaut(s) use(s) one or more extended reality devices to experience the earth extended reality service.

The present invention relates also to the earth extended reality service provided on a space platform by implementing the method as previously described and to a system designed to provide said earth extended reality service on a space platform, wherein said system comprises:
one or more acquisition systems/devices installed on earth and configured to acquire real-time data related to a surrounding ground environment and/or to one or more ground users in said ground environment; and
a computer graphics processing device/system that is installed on earth or on a space platform or, with a distributed architecture, partially on earth and partially on a space platform, and that is configured to receive the acquired real-time data and to carry out the steps b) and c) of the method as previously described.

The present invention stems from Applicant's idea of exploiting an admixture of real-time data generated in outer space (e.g., images, video, audio, data related to facial expression of astronauts, etc.) with synthetic data (e.g., Computer-Aided Design (CAD) models, terrain maps, digital twin systems/models, etc.) generated by computer graphics applications such as Computer-Generated Imagery (CGI) programs for the purpose of their conversion and utilization in real time as 3D immersive environments on earth. Obviously, the opposite scenario (i.e., creation in space of 3D immersive environments that reproduce places and people on ground) is also possible. The steps of the process according to the present invention can be conveniently divided into the following main activities:
capturing/generating/producing/acquiring real-time data, in particular real-time images and/or photos and/or videos and/or audios and/or point clouds, in a space environment;
processing and transmitting the real-time data to ground;
referencing the received data to predefined synthetic data of the space environment available on earth (e.g., digital twins of space modules/vehicles/outposts); and.
virtually reproducing in real time on earth the space environment and the activities performed by astronauts in said space environment.

The communication systems installed on board current inhabited space modules provide for the monitoring, management and control of the onboard audio and video channels (and of the data coming from the onboard data management system) and their transmission to the space controls centers on earth.

Conveniently, in addition to the conventional communication system on board space vehicles/modules/landers, additional devices can be advantageously installed on board, which are capable of tracking and collecting additional real-time data related to the space environment and astronauts' movements and facial expressions and which are connected to the existing systems (e.g., to the onboard communication switching matrix device). The captured signals can be, then, sent and elaborated in real time on earth (or wherever useful) in order to recreate the captured remote environment by “mixing” the real-time data with predefined synthetic data. The remote extended reality environment thus generated by combining real-time and synthetic data can be conveniently for example, point-to-point (P2P) exploited by using, communication networks (e.g., for ground control remote support) or broadcast networks (e.g., for educational, gaming, metaverse, etc. applications).

The attached FIGURE schematically illustrates an example of high-level system architecture according to an embodiment of the present invention.

As shown in the attached FIGURE, acquisition systems/devices 1 installed on board a space platform 2 (e.g., a space module, a space vehicle, a spaceship, etc.) are used to acquire real-time data related to a surrounding space environment and/or to one or more astronauts 3 in said space environment (e.g., images and/or photos and/or video data and/or audio data and/or data—e.g., point clouds—digitally representing body position and/or body attitude and/or facial expression of the astronaut(s) 3, etc.).

The acquired real-time data are then transmitted to earth (for example, by means of a traditional onboard telemetry system) where a ground computer graphics processing device/system 4 uses the received data to create/produce/generate 3D avatar(s) of the astronaut(s) 3 reproducing movements, actions, facial expressions, voice, etc. of said astronaut(s) 3 within a 3D extended reality environment that reproduces the space environment and that is created/produced/generated based on synthetic data available on earth (such as CAD and/or digital twin models).

The ground computer graphics processing device/system 4 outputs a stream of data that is transmitted to one or more ground users 5 via one or more ground communication systems/networks, and the user(s) 5 use(s) extended Reality (XR) devices 6 (e.g., Virtual Reality (VR) headset(s), Augmented Reality (AR) glasses, etc.) to enjoy the 3D extended reality environment with the avatar(s) of the astronaut(s) 3 whereby the ground user(s) 5 experience(s) the same immersive environment as the one in which the astronaut(s) 3 is/are operating.

In this connection, it is worth noting that, in the example shown in the attached FIGURE, the ground computer graphics processing device/system 4 is installed on earth. However, according to two different embodiments, the computer graphics processing device/system might be installed on the space platform 2 or could be implemented with a distributed architecture whereby computer graphics processing means are partially installed on the space platform 2 and partially on earth.

The present invention can be advantageously exploited for space-ground and ground-space human-to-human communications to:
provide a variety of services such as new methodologies for training astronauts or space tourists for future space tourism missions;
provide an advanced tool for remote technical support services provided by ground control centers;
enhance space entertainment business;
improve remote social interactions of astronauts with people on earth;
or the like.

The present invention allows circumventing the intrinsic problems/limitations of real-time transmission of huge quantities of data from space to earth and vice versa, problems/limitations that are mainly related to a bandwidth demand that cannot be satisfied with current space-to-ground and ground-to-space telecommunication systems.

These problems/limitations are overcome by the present invention by a combined use of a limited amount of “live” real-time data coming from space with a huge amount of “synthetic” data coming from digital twins available on ground (or vice versa).

In fact, the combined use of extended reality technologies and computer graphics technologies along with synthetic data allows lightening the real-time flow of data from space while still allowing to recreate on earth an immersive extended reality environment reproducing the remote space environment (or vice versa).

In particular, the present invention allows reproducing on ground astronauts' avatars including their facial expression along with the entire space environment in which they are moving with a delay mainly depending on the physical distance between earth and the relevant location in space (e.g., earth's orbit, lunar orbit, a mission to Mars, etc.) and only marginally on the time necessary for the computational reconstruction of the space environment in an immersive extended reality scenario.

The system according to the present invention is thus capable not only of transmitting 2D images of the space environment, as the conventional communication systems currently installed on space platforms, but it is capable of recreating, in real time, the same environment in immersive mode so as to have the perception for the final user “to be there”.

The present invention can be advantageously used for many applications such as onboard training and experiments, ground control centers operational support, astronauts remote family meetings, crew leisure activities, reduction of crew's psychosocial deprivation during long space exploration missions, and so on. Moreover, additional applications may also include video broadcasting, video gaming, educational/social applications, etc. Furthermore, national space agencies can benefit from the strong emotional impact of the system in order to increase awareness and affiliation of the general public to space-related activities.

It is worth noting that the system according to the present invention also allows to implement the same concepts in the opposite communication direction, i.e., from earth to space. In fact, the same service can be used to let the space crew enjoy an immersive extended reality ground environment, thus contributing to offering the crew a very valuable tool for psycho-social countermeasures.

As previously explained, all the current communication solutions in the space domain utilize only 2D videos/images as visive communication media, while synthetic data like CAD models are used only to reproduce “off-line” 3D objects or VR environments.

In other words, nowadays, the synthetic material generated following the design of the spatial modules (e.g., CAD models) as well as the telemetry data transmitted by space modules are used and managed only in asynchronous mode, namely to reproduce “off-line” virtual environments in order to facilitate activities such as engineering or usability tests, etc.

On the contrary, the present invention provides for use of real-time data acquired in space in combination with synthetic data (e.g., digital twins) generated on earth to virtually reproduce on ground in real time astronauts' activities in an immersive virtual space scenario.

Being the space domain, and even more in particular the human space exploration, particularly interested for safety reasons, but not only, in the aspects of communication—both of telemetry data and of interpersonal communications between the space crew and the personnel of the ground control centers—the present invention may result in a valuable help and improvement in human-to-human communications.

In addition to the use of the present invention in the strict context of space, if applied to a wider audience (like for educational, entertainment, etc. applications), the emotional impact perceived by the subjects while using the system can amplify user involvement in the activity.

Thence, the present invention has a double value: on the one hand, that of improving the quality of communications and interactions between the space crew and the ground personnel and, on the other hand, applied to a vast public, that of making the themes related to space more fascinating and engaging.

In fact, the present invention is based on a new extended reality functional architecture that, by combining real-time data generated in space installations with data related to 3D digital models of known configurations (i.e., digital twins) of space infrastructures, is capable of offering services to different categories of end users, both in the space field as in the non-space.

In summary, the different industrial and commercial In applications of the present invention can be classified into at least the following main four categories:
1) Scientific—remote real-time verification of the experiments carried out by astronauts interacting with the researchers in presence from the earth with extended reality techniques;
2) Training—virtual experiential training, even with the direct involvement of astronauts in space, living their instructions and real experiences in real time: personal trainers in the field;
3) Edu-Entertainment—knowledge promotion and mass information with the most modern XR technologies;
4) Commercial—promotion of space assets and onboard products towards the general public.

From the foregoing, the innovative features and the technical advantages of the present invention are immediately clear to those skilled in the art.

In conclusion, it is clear that numerous modifications and variants can be made to the present invention, all falling within the scope of protection of the invention, as defined in the appended claims.

1. A method of providing a space extended reality service on earth, comprising:
a) acquiring, by means of one or more acquisition systems/devices (1) installed on a space platform (2), real-time data related to a surrounding space environment and/or to one or more astronauts (3) in said space environment;
b) generating, by means of a computer graphics processing device/system (4), based on the acquired real-time data and on synthetic data, a three-dimensional extended reality environment reproducing the space environment and one or more three-dimensional avatar(s) of the astronaut(s) (3) reproducing movements and/or actions and/or facial expressions and/or voice of said astronaut(s) (3), wherein the synthetic data digitally represent the space environment and/or the astronaut(s) (3); and
c) providing one or more users (5) on earth with a space extended reality service based on the generated three-dimensional extended reality environment and avatar(s).

2. The method of claim 1, wherein the real-time data include data such as point clouds or the like that digitally represent body position and/or body attitude and/or facial expression of the astronaut(s) (3).

3. The method according to claim 1, wherein the real-time data include images and/or photos and/or video data and/or audio data.

4. The method according to claim 1, wherein the synthetic data are produced based on one or more computer-aided design models and/or one or more digital twin models that digitally represent the space environment and/or the astronaut(s) (3).

5. The method according to claim 1, wherein the user(s) (5) use(s) one or more extended reality devices (6) to experience the space extended reality service.

6. A space extended reality service provided on earth by implementing the method as claimed in claim 1.

7. A system designed to provide a space extended reality service on earth, comprising:
one or more acquisition systems/devices (1) installed on a space platform (2) and configured to acquire real-time data related to a surrounding space environment and/or to one or more astronauts (3) in said space environment; and
a computer graphics processing device/system (4) configured to receive the acquired real-time data and to carry out the steps b) and c) of the method as claimed in claim 1.

8. A method of providing an earth extended reality service on a space platform, comprising:
a) acquiring, by means of one or more acquisition systems/devices installed on earth, real-time data related to a surrounding ground environment and/or to one or more ground users in said ground environment;
b) generating, by means of a computer graphics processing device/system, based on the acquired real-time data and on synthetic data, a three-dimensional extended reality environment reproducing the ground environment and one or more three-dimensional avatar(s) of the ground user(s) reproducing movements and/or actions and/or facial expressions and/or voice of said ground user(s), wherein the synthetic data digitally represent the ground environment and/or the ground user(s); and
c) providing one or more astronauts on a space platform with an earth extended reality service based on the generated three-dimensional extended reality environment and avatar(s).

9. The method of claim 8, wherein the real-time data include data such as point clouds or the like that digitally represent body position and/or body attitude and/or facial expression of the ground user(s).

10. The method according to claim 8, wherein the real-time data include images and/or photos and/or video data and/or audio data.

11. The method according to claim 8, wherein the synthetic data are produced based on one or more computer-aided design models and/or one or more digital twin models that digitally represent the ground environment and/or the ground user(s).

12. The method according to claim 8, wherein the astronaut(s) use(s) one or more extended reality devices to experience the earth extended reality service.

13. An earth extended reality service provided on a space platform by implementing the method as claimed in claim 8.

14. A system designed to provide an earth extended reality service on a space platform, comprising:
one or more acquisition systems/devices installed on earth and configured to acquire real-time data related to a surrounding ground environment and/or to one or more ground users in said ground environment; and
a computer graphics processing device/system configured to receive the acquired real-time data and to carry out the steps b) and c) of the method as claimed in claim 8.
